(19) United States
(12) Patent Application Publication
(10) Pub. No.: US 2018/0351766 A1
(43) Pub. Date: Dec. 6, 2018

(54) TRANSMISSION SYSTEM, TRANSMISSION DEVICE, AND LOOP PREVENTION METHOD

(71) Applicant: FUJITSU LIMITED, Kawasaki-shi (JP)

(72) Inventors: Shotaro Koshinuma, Kawasaki (JP); Yuji Mori, Inagi (JP); Hironori Mieno, Kawasaki (JP); Katsumi Shimada, Machida (JP)

(73) Assignee: FUJITSU LIMITED, Kawasaki-shi (JP)

(21) Appl. No.: 15/994,036

(22) Filed: May 31, 2018

(30) Foreign Application Priority Data
Jun. 2, 2017 (JP) 2017-110241

(51) Int. Cl. H04L 12/437; H04L 12/709; H04L 12/24

(52) U.S. Cl. CPC H04L 12/437; H04L 41/0659; H04L 45/245

(57) ABSTRACT

A transmission device being one of two transmission devices connected with each other among a plurality of transmission devices connected in a ring configuration in a ring protection link, the transmission device includes a processor configured to have a link aggregation connection with a second transmission device not included in the ring configuration, detect a failure with one of the plurality of transmission devices connected in the ring configuration, and when the failure is detected, set a blocking point at a link side port connecting the first transmission device to another one of the plurality of transmission devices connected in the ring configuration.

### CROSS-REFERENCE TO RELATED APPLICATION

This application is based upon and claims the benefit of priority of the prior Japanese Patent Application No. 2017-110241, filed on Jun. 2, 2017, the entire contents of which are incorporated herein by reference.

### FIELD

The embodiments discussed herein are related to a transmission system, a transmission device, and a loop prevention method.

### BACKGROUND

In recent years, the future trend for a transmission system is a system having a ring configuration in which a ring protection scheme defined by International Telecommunication Union (ITU)-T G.8032 is connected to Multi-Chassis Link Aggregation (MC-LAG). MC-LAG is standardized by, for example, Institute of Electrical and Electronics Engineers (IEEE) 802.1 AX-2014. It is possible for MC-LAG to increase redundancy compared with a normal LAG.

FIG. 12 is an explanatory diagram illustrating an example of a transmission system 200. The transmission system 200 illustrated in FIG. 12 is a transmission system in which an MC-LAG configuration is connected to a ring protection link. The transmission system 200 includes a plurality of nodes 202, for example, a first node 202A to a sixth node 202F. In the transmission system 200, a ring protection link is configured, for example, by a ring connection in path order of the first node 202A, the second node 202B, the third node 202C, the fourth node 202D, the fifth node 202E, and the first node 202A. In this regard, it is assumed that the sixth node 202F does not belong to the ring protection link. Further, the first node 202A and the second node 202B have a LAG connection to the sixth node 202F so as to configure an MC-LAG. In the transmission system 200, it is assumed that, for example, a blocking point X100 that breaks the link between the fourth node 202D and the fifth node 202E is set.

In the transmission system 200, for example, the sixth node 202F transmits packets to the third node 202C via the first node 202A and the second node 202B. Further, it is possible for the transmission system 200 to avoid a loop in the ring protection depending on the blocking point X100 that breaks a link between the fourth node 202D and the fifth node 202E in the ring protection.

Related-art techniques are disclosed in Japanese Laid-open Patent Publication Nos. 2004-147172 and 2011-193403.

It is assumed that in the transmission system 200, for example, while packets are transmitted from the sixth node 202F to the third node 202C via the first node 202A and the second node 202B, a failure Y100 has occurred in the inter-MC link between the first node 202A and the second node 202B.

If a failure occurs in an inter-MC link, the transmission system 200 releases the blocking point X100 currently set so that packets go around all over the paths. For example, if packets input into the transmission system 200 from the outside are multicast or broadcast packets, copied packets are returned to an input line, and thus the bandwidth of the network line is oppressed. For example, in the transmission system 200, packets are transferred along a path from the sixth node 202F to the first node 202A→the fifth node 202E→the fourth node 202D→the third node 202C→the second node 202B→the sixth node 202F. As a result, a loop occurs in which packets output by a node are returned to the node itself at the sixth node 202F, which oppresses the communication bandwidth.

According to an aspect of the present disclosure, it is desirable to provide a transmission system, or the like capable of avoiding the occurrence of a loop even if an inter-MC link failure occurs.

### SUMMARY

According to an aspect of the embodiments, a transmission device being one of two transmission devices connected with each other among a plurality of transmission devices connected in a ring configuration in a ring protection link, the transmission device includes a processor configured to have a link aggregation connection with a second transmission device not included in the ring configuration, detect a failure with one of the plurality of transmission devices connected in the ring configuration, and when the failure is detected, set a blocking point at a link side port connecting the first transmission device to another one of the plurality of transmission devices connected in the ring configuration.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an example of a transmission system according to the present embodiment;

FIG. 2 is an explanatory diagram illustrating an example of the hardware configuration of a first node;

FIG. 3 is an explanatory diagram illustrating an example of the functional configuration of a CPU in the first node;

FIG. 4 is an explanatory diagram illustrating an example of a port attribute table;

FIG. 5 is an explanatory diagram illustrating an example of the processing operation of the first node and a second node when a frame is input from a ring protection side port;

FIG. 6 is an explanatory diagram illustrating an example of the processing operation of the first node and the second node when a frame is input from an MC-LAG side port;

FIG. 7 is a flowchart illustrating an example of the processing operation of the CPU in the first node involved in transfer processing;

FIG. 8 is an explanatory diagram illustrating an example of a setting location of a blocking point before and after an inter-MC link failure;

FIG. 9 is a flowchart illustrating an example of the processing operation of the CPU in the second node involved in failure detection processing;

FIG. 10 is an explanatory diagram illustrating an example of the setting location of a blocking point before and after an inter-MC link failure according to a second embodiment;

FIG. 11 is an explanatory diagram illustrating an example of a communication device that executes a loop prevention program; and

FIG. 12 is an explanatory diagram illustrating an example of a transmission system.

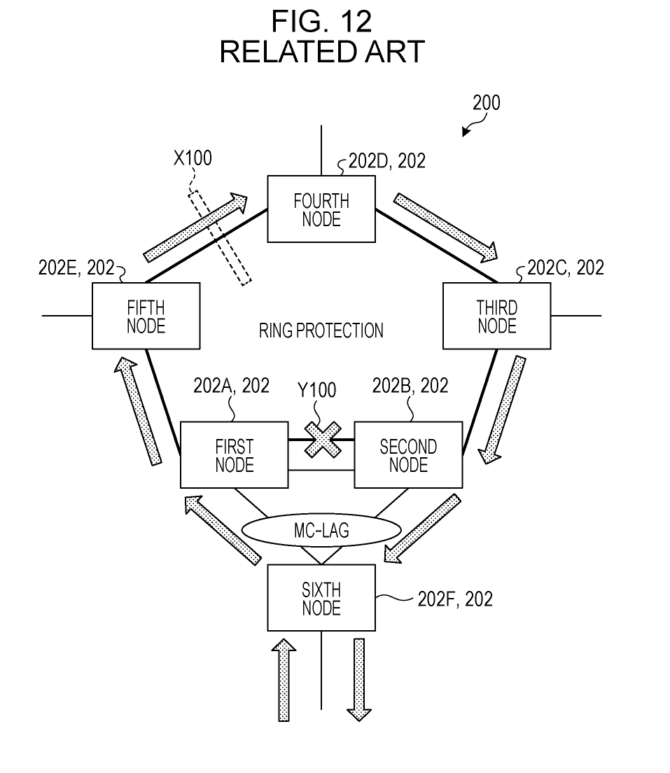

### DESCRIPTION OF EMBODIMENTS

In the following, detailed descriptions will be given of a transmission system, a transmission device, and a loop prevention method according to embodiments of the present disclosure with reference to the drawings. In this regard, the disclosed technique is not limited by these embodiments. Also, it is possible to suitably combine the embodiments described below within a range that does not cause inconsistencies.

### First Embodiment

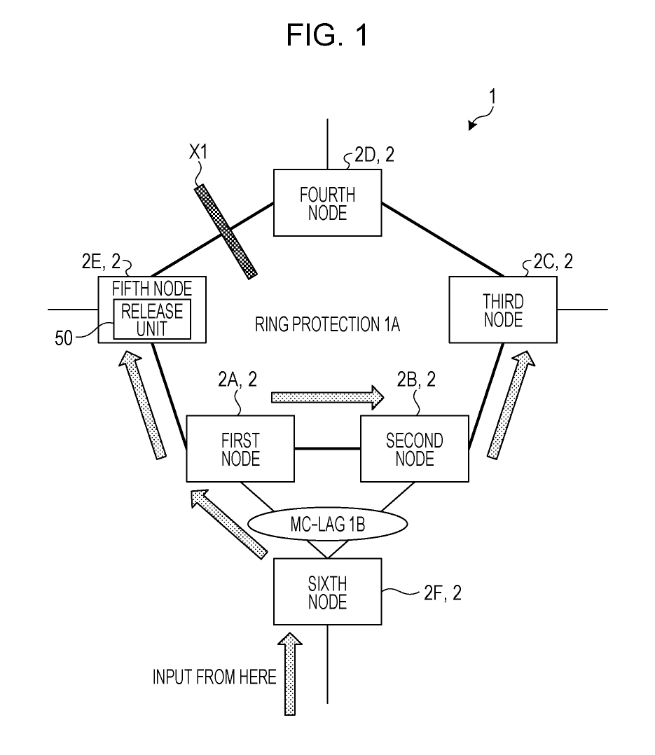

FIG. 1 is an explanatory diagram illustrating an example of a transmission system 1 according to the present embodiment. The transmission system 1 illustrated in FIG. 1 is configured by connecting a ring protection 1A and a Multi-Chassis Link Aggregation (MC-LAG) 1B. The transmission system 1 includes a plurality of nodes 2, for example, a first node 2A to a sixth node 2F. The first node 2A is connected to the ring-protection 1A side fifth node 2E, and the MC-unit link side second node 2B and the MC-LAG 1B side sixth node 2F. The second node 2B is connected to the ring-protection 1A side third node 2C, and the MC-LAG 1B side sixth node 2F. The third node 2C is connected to the ring-protection 1A side fourth node 2D. The fourth node 2D is connected to the ring-protection 1A side fifth node 2E. The sixth node 2F is connected to a client not illustrated in FIG. 1.

The transmission system 1 forms a ring protection 1A, for example, by a ring connection in path order of the first node 2A to the second node 2B→the third node 2C→the fourth node 2D→the fifth node 2E→the first node 2A. Further, the first node 2A and the second node 2B form a part of the ring configuration for the ring protection 1A. Further, the first node 2A and the second node 2B form an MC-LAG 1B by a LAG connection to the sixth node 2F. The first node 2A and the second node 2B have the functions of the ring protection 1A and the functions of the MC-LAG 1B. It is assumed that the link between the first node 2A and the second node 2B is an inter-MC link. The fifth node 2E sets a blocking point X1 in the link with the fourth node 2D in order to avoid the occurrence of a loop in which packets are returned, for example, along the path from the sixth node 2F to the first node 2A→the fifth node 2E→the fourth node 2D→the third node 2C→the second node 2B→the sixth node 2F. The fifth node 2E includes a release unit 50 that releases the blocking point X1, for example, if a failure is detected in the inter-MC link. In this regard, for convenience of explanation, only the fifth node 2E includes the release unit 50. However, each node 2 includes the release unit 50 and is capable of releasing a blocking point, which is set by its respective node. It is possible for the blocking point X1 to avoid the occurrence of a loop that oppresses the bandwidth of a network line by the copied packets returning to the input line, for example, in the case where externally input packets are multicast packets.

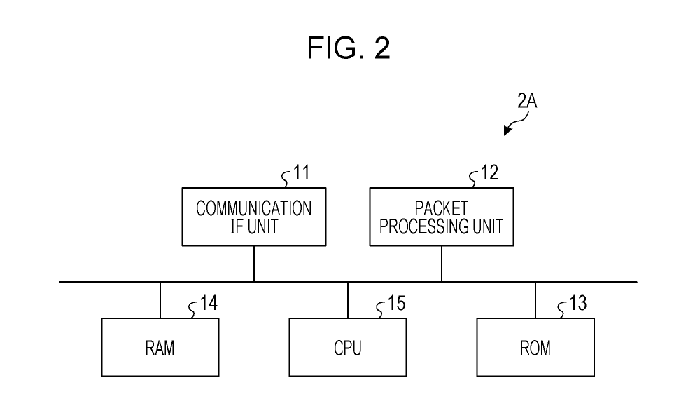

FIG. 2 is an explanatory diagram illustrating an example of the hardware configuration of the first node 2A. In this regard, for convenience of explanation, the configuration of the first node 2A is exemplified, and by giving the same sign to the same component as that of the second node 2B, a description will be omitted of the duplicated component and operation.

The first node 2A includes a communication interface (IF) unit 11, a packet processing unit 12, a read only memory (ROM) 13, a random access memory (RAM) 14, and a central processing unit (CPU) 15. The communication IF unit 11 is an IF unit that includes a plurality of physical ports and controls packet communication that inputs and outputs frames via ports. The packet processing unit 12 is a circuit that controls the signal processing of the packets in a frame. The ROM 13 is an area that stores various kinds of information, such as a program, or the like. The RAM 14 is a storage area for storing various kinds of information, for example, information that the CPU 15 uses as a work area. The CPU 15 controls the entire first node 2A.

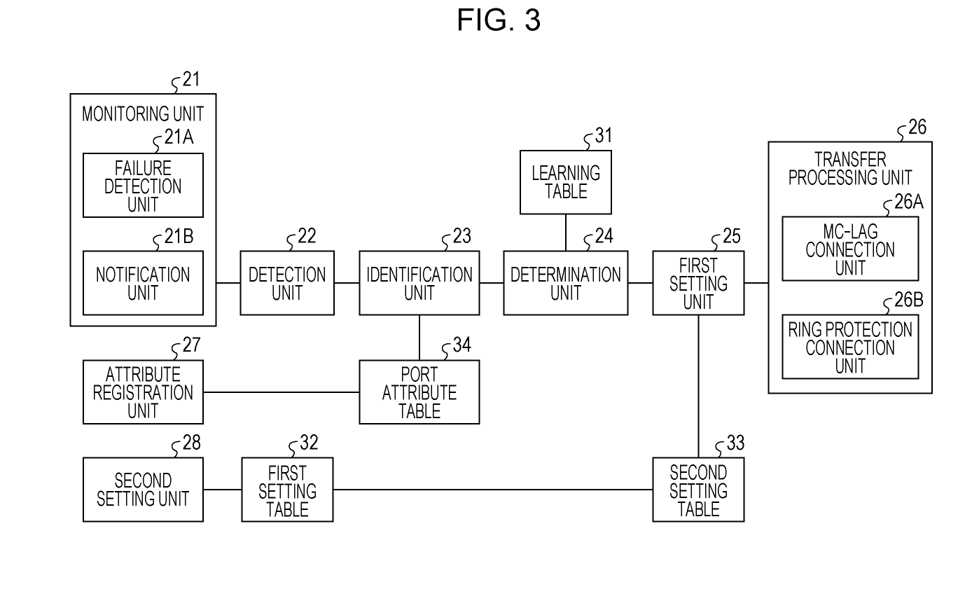

FIG. 3 is an explanatory diagram illustrating an example of the functional configuration of a CPU 15 in the first node 2A. The CPU 15 illustrated in FIG. 3 includes a monitoring unit 21, a detection unit 22, an identification unit 23, a determination unit 24, a first setting unit 25, a transfer processing unit 26, an attribute registration unit 27, and a second setting unit 28. Further, the RAM 14 includes a learning table 31, a first setting table 32, a second setting table 33, and a port attribute table 34.

The learning table 31 is an area in which a port number that identifies a transmission port of a transfer destination is managed in association with each port number that identifies a reception port. In this regard, the table contents of the learning table 31 are updated in accordance with the transfer result of the transfer processing. The first setting table 32 is an area that manages the setting information that indicates whether the node is a master or a slave. The second setting table 33 is an area in which, for example, if the node is a slave, a blocking point for blocking a ring protection 1A side port, that is to say, a blocking target port is managed. The port attribute table 34 is an area in which the port attribute that identifies a link type connecting to the port is managed for each port of the node.

The monitoring unit 21 monitors input and output of frames via a port. The monitoring unit 21 includes a failure detection unit 21A that detects a failure and a notification unit 21B that notifies all the nodes 2 in the ring protection 1A of detection of a failure. The detection unit 22 detects, for example, a port number for identifying a target port P, such as a reception port, a transmission port, or the like. The identification unit 23 identifies a port attribute corresponding to the port number from port attribute table 34 in accordance with the port number of the target port P. The determination unit 24 refers to the learning table 31 and the port attribute table 34, and determines a transfer destination.

The first setting unit 25 sets a blocking point for blocking the ring protection 1A side port based on the table contents of the second setting table 33 at the time of detecting an inter-MC link failure. The transfer processing unit 26 performs transfer processing of a received frame. The transfer processing unit 26 includes an MC-LAG connection unit 26A and a ring protection connection unit 26B. The MC-LAG connection unit 26A is a processing unit for establishing a LAG connection with the sixth node 2F in cooperation with the second node 2B. The ring protection connection unit 26B is a processing unit for establishing a link connection with the fifth node 2E of the ring protection 1A side.

The attribute registration unit 27 performs setting registration of the port attribute for each port number in the port attribute table 34 in accordance with a predetermined operation. The second setting unit 28 registers setting information indicating whether or not the node is a master or a slave in accordance with a predetermined operation in the first setting table 32. The first setting unit 25 detects a failure of an inter-MC link, and if the node is a slave, the first setting unit 25 sets a blocking point at the ring protection 1A side port based on the setting contents of the second setting table 33. In this regard, the ring protection 1A side port is for example, “P2” in the case of the first node 2A.

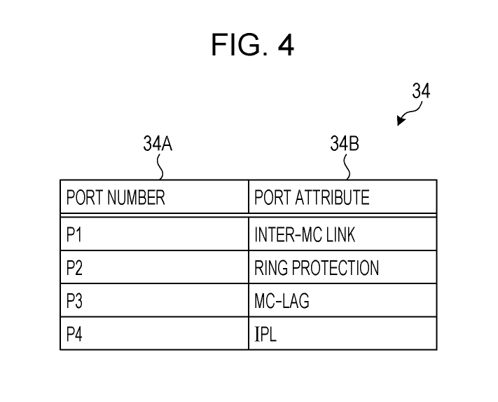

FIG. 4 is an explanatory diagram illustrating an example of the port attribute table 34. The port attribute table 34 illustrated in FIG. 4 is an area in which a port attribute 34B is managed in accordance with each port number 34A. A port number 34A is identification information that identifies the node port P. A port attribute 34B is type information that identifies the type of the link destination of the port P. A port attribute 34B has types, for example, “ring protection”, “MC-LAG”, “Inter Portal Link (IPL)”, “inter-MC link”, or the like. “Ring protection” of the port attribute 34B is a port that connects to the ring protection 1A side link. “MC-LAG” of the port attribute 34B is a port for connecting to the MC-LAG 1B side link. “IPL” of the port attribute 34B is a port that connects to the IPL side link. “Inter-MC link” of the port attribute 34B is a port that connects to an inter-MC link.

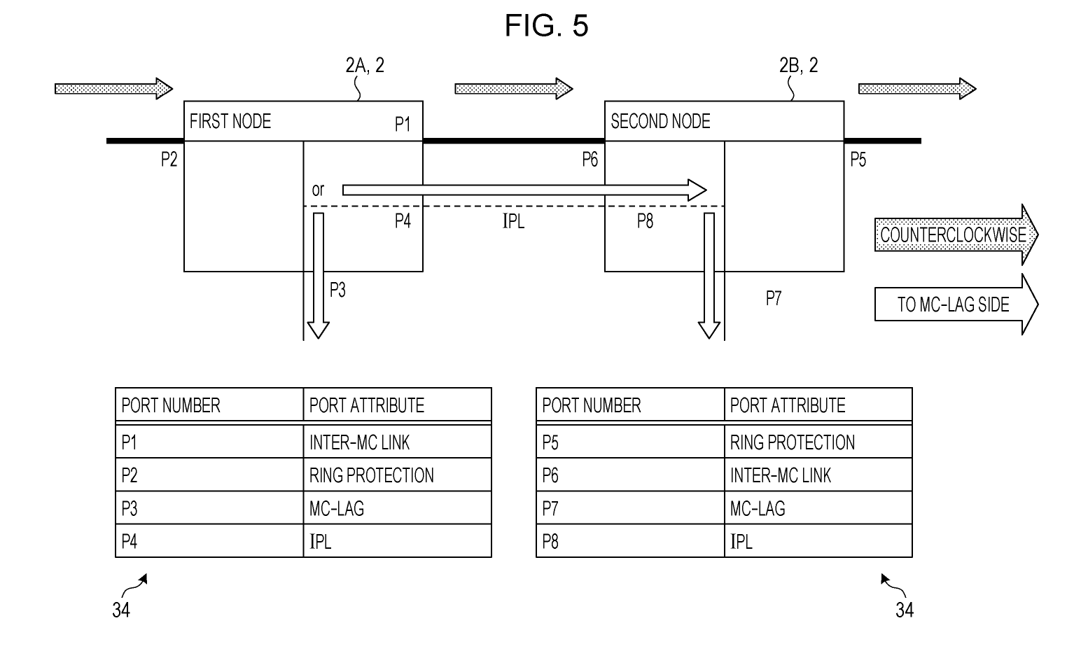

FIG. 5 is an explanatory diagram illustrating an example of the processing operation of the first node 2A and the second node 2B when a frame is input from a ring protection 1A side port P. The first node 2A has a port P1 for connecting to an inter-MC link, a port P2 for connecting to a ring protection 1A side link, a port P3 for connecting to an MC-LAG 1B side link, and a port P4 for connecting to IPL side link. The second node 2B has a port P5 for connecting to a ring protection 1A side link, a port P6 for connecting to an inter-MC link, a port P7 for connecting an MC-LAG 1B side link, and a port P8 for connecting to an IPL side link.

The first node 2A performs LAG distribution processing in accordance with the frame input from the ring protection 1A side port P1 connected to the fifth node 2E. Also, the first node 2A prohibits transferring packets to the MC-LAG 1B side port P3 connected to the sixth node 2F in accordance with input from the inter-MC link side port P1 connected to the second node 2B.

The second node 2B performs LAG distribution processing in accordance with the frame input from the ring protection 1A side port P5 of the third node 2C. Also, the second node 2B prohibits transferring packets to the MC-LAG 1B side port P7 connected to the sixth node 2F in accordance with input from the inter-MC link side port P6 connected to the first node 2A.

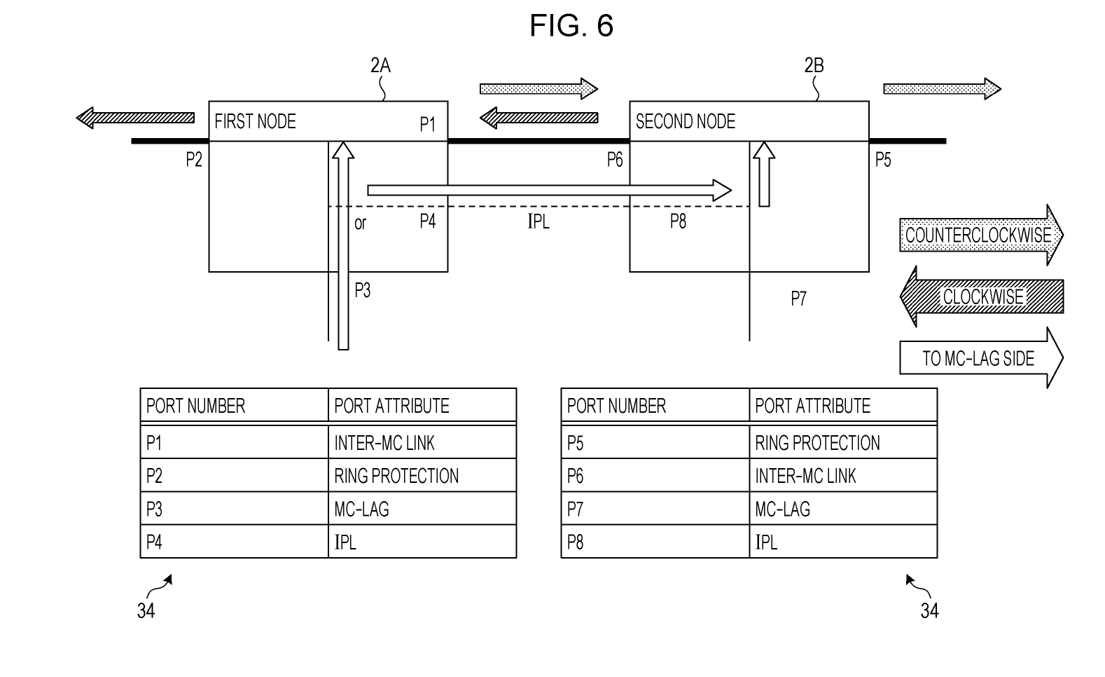

FIG. 6 is an explanatory diagram illustrating an example of the processing operation of the first node 2A and the second node 2B when a frame is input from the MC-LAG 1B side port P. The first node 2A performs LAG distribution processing in accordance with the frame input from the MC-LAG 1B side port P3 connected to the sixth node 2F. Also, the first node 2A prohibits transferring packets to the MC-LAG 1B side port P3 connected to the sixth node 2F in accordance with input from the inter-MC link side port P1 connected to the second node 2B.

The second node 2B performs LAG distribution processing in accordance with the frame input from the MC-LAG 1B side port P7 connected to the sixth node 2F. Also, the second node 2B prohibits transferring packets to the MC-LAG 1B side port P7 connected to the sixth node 2F in accordance with input from the inter-MC link side port P6 connected to the first node 2A.

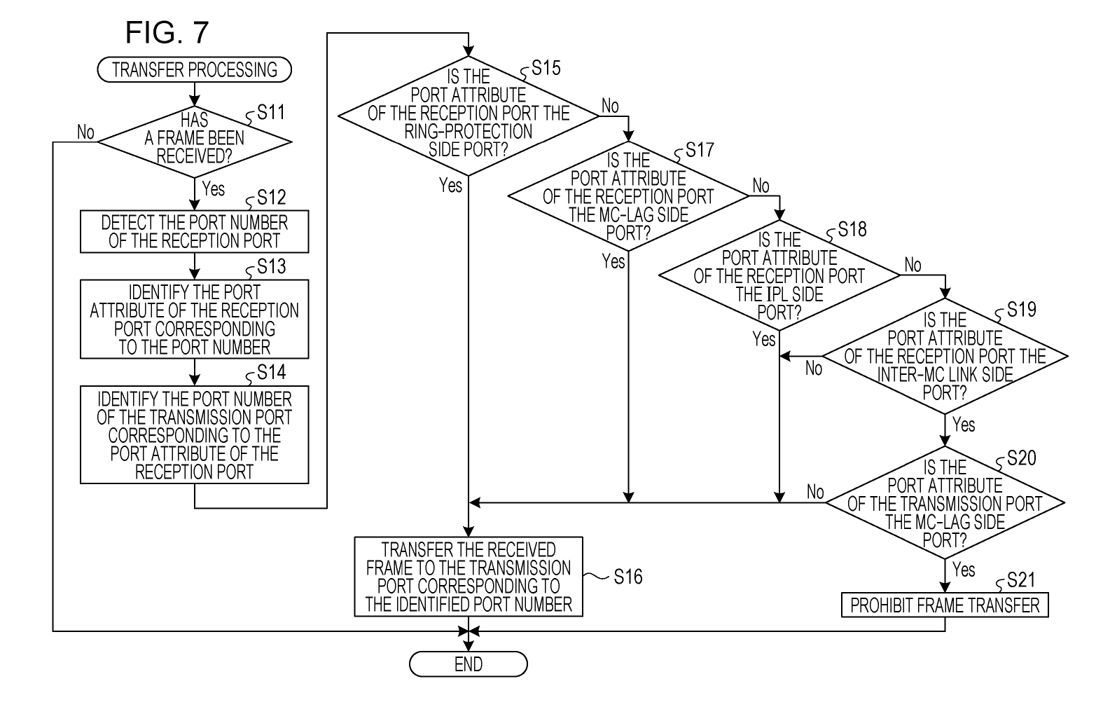

Next, a description will be given of the operation of the transmission system 1 according to the first embodiment. FIG. 7 is a flowchart illustrating an example of the processing operation of the CPU 15 in the first node 2A involved in transfer processing. In FIG. 7, a determination is made as to whether the monitoring unit 21 of the CPU 15 in the first node 2A has received a frame (step S11). If the detection unit 22 in the CPU 15 receives a frame (step S11 affirmation), the detection unit 22 detects the port number of the reception port that has received a frame (step S12). The identification unit 23 in the CPU 15 refers to the port attribute table 34 and identifies the port attribute of the reception port corresponding to the port number of the reception port (step S13).

The determination unit 24 in the CPU 15 refers to the learning table 31 and identifies the port number of the transmission port corresponding to the port attribute of the reception port (step S14). The determination unit 24 determines whether or not the port attribute of the reception port is the ring protection 1A side port (step S15). In this regard, the ring protection 1A side port is the port P2 that connects to the fifth node 2E side link in the ring protection 1A in the case of the first node 2A.

If the port attribute of the reception port is the ring protection 1A side port (step S15 affirmation), the transfer processing unit 26 in the CPU 15 transfers a received frame to the transmission port corresponding to the port number identified in step S14 (step S16). The CPU 15 then terminates the processing operation illustrated in FIG. 7.

If the port attribute of the reception port is not the ring protection 1A side port (step S15 negation), the determination unit 24 determines whether or not the port attribute of the reception port is the MC-LAG 1B side port (step S17). In this regard, if the MC-LAG 1B side port is the port P3 that connects to the sixth node 2F side link connected to the MC-LAG 1B in the case of the first node 2A. If the port attribute of the reception port is the MC-LAG 1B side port (step S17 affirmation), the processing of the transfer processing unit 26 proceeds to step S16 in order to transfer the received frame to the transmission port corresponding to the port number identified in step S14.

If the port attribute of the reception port is not the MC-LAG 1B side port (step S17 negation), the determination unit 24 determines whether or not the port attribute of the reception port is the IPL side port (step S18). In this regard, the IPL side port is the port P4 that connects to the second node 2B side link of the IPL in the case of the first node 2A. If the port attribute of the reception port is the IPL side port (step S18 affirmation), the processing of the transfer processing unit 26 proceeds to step S16 in order to transfer the received frame to the transmission port corresponding to the port number identified in step S14.

If the port attribute of the reception port is not the IPL side port (step S18 negation), the determination unit 24 determines whether or not the port attribute of the reception port is the inter-MC link side port (step S19). In this regard, the inter-MC link side port is the port P1 connected to the second node 2B, which is the inter-MC link in the case of the first node 2A. If the port attribute of the reception port is the inter-MC link side port (step S19 affirmation), the determination unit 24 determines whether or not the port attribute of the transmission port is the MC-LAG 1B side port (step S20). If the port attribute of the transmission port is the MC-LAG 1B side port (step S20 affirmation), the transfer processing unit 26 prohibits transferring the received frame to the MC-LAG 1B side port (step S21) and terminates the processing operation illustrated in FIG. 7.

If the port attribute of the reception port is not the inter-MC link side port (step S19 negation), the processing of the transfer processing unit 26 proceeds to step S16 in order to transfer the received frame to the transmission port corresponding to the port number. If the port attribute of the transmission port is not the MC-LAG 1B side port (step S20 negation), the processing of the transfer processing unit 26 proceeds to step S16 in order to transfer the received frame to the transmission port corresponding to the port number.

If the port attribute of the reception port is the ring protection 1A side port, the MC-LAG 1B side port, or the IPL side port in accordance with detection of the received frame, the CPU 15 transfers a frame to the transmission port of the reception port.

Also, if the port attribute of the reception port is the inter-MC link side port, and the port attribute of the transmission port is the MC-LAG 1B side port, the CPU 15 prohibits transferring the received frame. As a result, it is possible to avoid the occurrence of a loop in the ring protection 1A in which a received frame from the sixth node 2F is returned to the sixth node 2F.

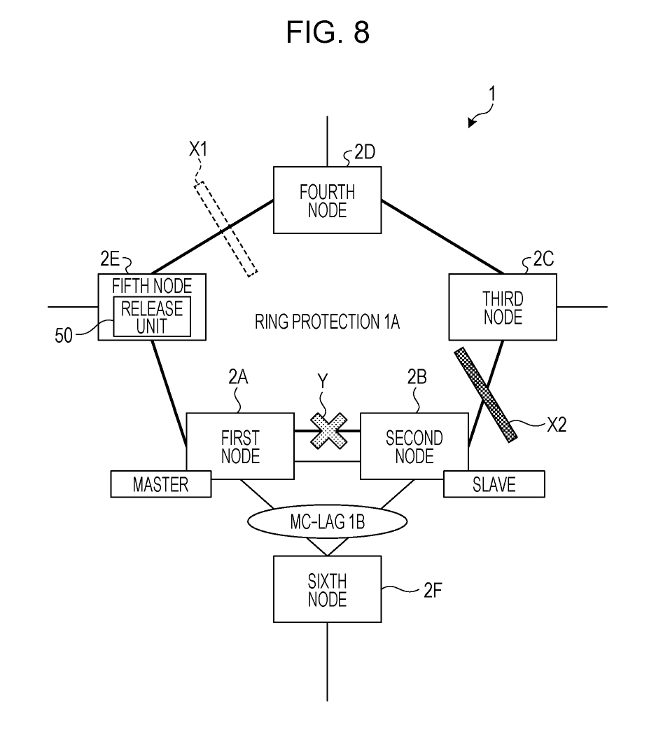

FIG. 8 is an explanatory diagram illustrating an example of the setting location of a blocking point before and after an inter-MC link failure. It is assumed that the transmission system 1 illustrated in FIG. 8 sets a blocking point X1, for example, at a port in the fifth node 2E of the link side connected to the fourth node 2D. In order to avoid a loop in which, for example, packets are returned along the path from the sixth node 2F to the first node 2A→fifth node 2E→fourth node 2D→third node 2C→second node 2B→sixth node 2F, the fifth node 2E sets a blocking point X1 in the link with the fourth node 2D. Further, it is assumed that a failure Y has occurred in the inter-MC link between the first node 2A and the second node 2B.

If the second node 2B detects a failure Y in the inter-MC link with the first node 2A, the second node 2B notifies all the nodes 2 in the ring protection 1A of a failure notification signal. If the release unit 50 in the fifth node 2E detects a failure notification signal, the fifth node 2E releases the set blocking point X1. Further, since the second node 2B is a slave, the second node 2B refers to the second setting table 33 and sets a blocking point X2 at the ring protection 1A side port P5 connecting to the third node 2C. That is to say, in order to avoid a loop in which packets are returned along the path from the sixth node 2F to the first node 2A→the fifth node 2E→the fourth node 2D→the third node 2C→the second node 2B→sixth node 2F, a blocking point X2 is set in the link between the third node 2C and the second node 2B. As a result, it is possible to avoid a loop of the received frame from the MC-LAG 1B of the second node 2B by flooding of each node 2 in the transmission system 1 caused by the inter-MC link failure.

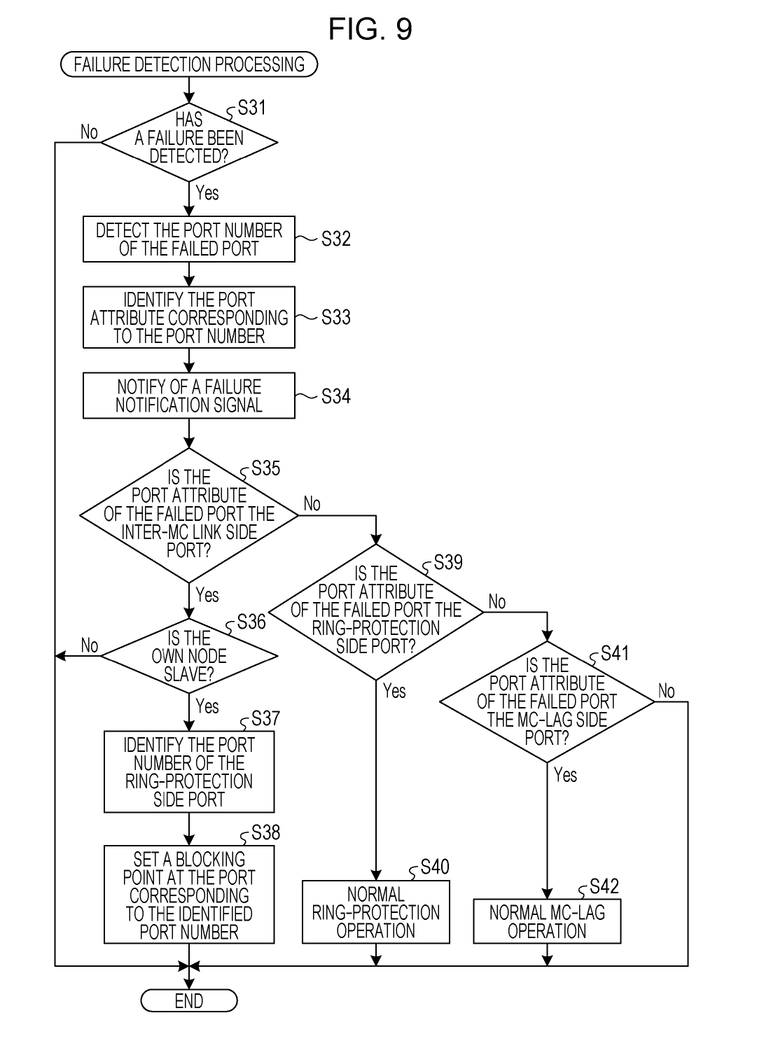

FIG. 9 is a flowchart illustrating an example of the processing operation of the CPU 15 in the second node 2B involved in failure detection processing. In FIG. 9, the failure detection unit 21A in the CPU 15 determines whether or not a failure has been detected (step S31). If the detection unit 22 detects a failure (step S31 affirmation), the detection unit 22 detects the port number of the failed port (step S32). The identification unit 23 identifies the port attribute of the failed port corresponding to the port number from the port attribute table 34 (step S33).

The transfer processing unit 26 notifies all the nodes 2 in the ring protection 1A of a failure notification signal (step S34). The determination unit 24 determines whether or not the port attribute of the failed port is the inter-MC link side port (step S35). In this regard, the inter-MC link side port is the port P6 that connects to the first node 2A side link in the case of the second node 2B.

If the port attribute of the failed port is the inter-MC link side port (step S35 affirmation), the determination unit 24 refers to the first setting table 32 and determines whether or not the second node 2B is a slave (step S36). If the second node 2B is a slave (step S36 affirmation), the first setting unit 25 refers to the second setting table 33 and identifies the port number the ring protection 1A side port of the second node 2B (step S37). In this regard, the ring protection 1A side port is the port P5 that connects to the third node 2C in the ring protection 1A in the case of the second node 2B. The first setting unit 25 sets a blocking point X2 at the identified ring protection 1A side port (step S38) and terminates the processing operation illustrated in FIG. 9. That is to say, the second node 2B blocks the port P5 that connects to the third node 2C side link. If the determination unit 24 has not detected a failure (step S31 negation), or the second node 2B is not a slave (step S36 negation), the determination unit 24 terminates the processing operation illustrated in FIG. 9.

If the port attribute of the failed port is not the inter-MC link side port (step S35 negation), the determination unit 24 determines whether or not the port attribute of the failed port is the ring protection 1A side port (step S39). If the port attribute of the failed port is the ring protection 1A side port (step S39 affirmation), the ring protection connection unit 26B performs the normal ring protection operation (step S40) and terminates the processing operation illustrated in FIG. 9.

If the port attribute of the failed port is not the ring protection 1A side port (step S39 negation), the determination unit 24 determines whether or not the port attribute of the failed port is the MC-LAG 1B side port (step S41). In this regard, the MC-LAG 1B side port is the port P7 that connects to the MC-LAG 1B side sixth node 2F in the case of the second node 2B. If the port attribute of the failed port is the MC-LAG 1B side port (step S41 affirmation), the MC-LAG connection unit 26A performs the normal MC-LAG operation (step S42) and terminates the processing operation in FIG. 9. If the port attribute of the failed port is not the MC-LAG 1B side port (step S41 negation), the determination unit 24 terminates the processing operation illustrated in FIG. 9.

If the port attribute of the failed port is the inter-MC link side port, and second node 2B is a slave, the CPU 15 sets a blocking point X2 at the ring protection 1A side port. As a result, it is possible to avoid a loop in the ring protection 1A, in which a received frame from the sixth node 2F is returned to the sixth node 2F by flooding of each node 2 in the ring protection 1A caused by the inter-MC link failure.

If the second node 2B according to the first embodiment detects a failure of the inter-MC link, the second node 2B blocks the connecting side of the port P5 with the ring protection 1A side third node 2C. As a result, if a failure occurs in the inter-MC link, it is possible to avoid the occurrence of a loop in the ring protection 1A. For example, if packets that are input from the outside are multicast packets or broadcast packets, it is possible to avoid the occurrence of a loop that oppresses the bandwidth of the sixth node 2F, which is caused by the copied packets returning to the input line.

The second node 2B detects a failure in the inter-MC link and refers to the first setting table 32. If the second node 2B is a slave, the second node 2B blocks the port P5 on the side of connecting to the ring protection 1 side third node 2C. As a result, even if a failure occurs in the inter-MC link, it is possible to avoid the occurrence of a loop in the ring protection 1A.

The second node 2B refers to the port attribute table 34 and identifies a port attribute corresponding to the port number of the failed port. If the port attribute of the failed port is the inter-MC link, the second node 2B detects a failure in the inter-MC link failure. As a result, it is possible for the second node 2B to easily detect a failure in the inter-MC link.

In a network in which an MC-LAG 1B is connected to a ring configuration network, it is possible to avoid a multicast frame (broadcast frame) input to the network from returning to the place where the frame is input.

In this regard, in the first embodiment, the first node 2A is set to a master, and the second node 2B is set to a slave. However, the first node 2A may be set to a slave, and the second node 2B may be set to a master. A description will be given below as a second embodiment. In this regard, the same sign is given to the same component as that in the transmission system 1 according to the first embodiment, and a description will be omitted of the configuration and the operation of the overlapping component.

### Second Embodiment

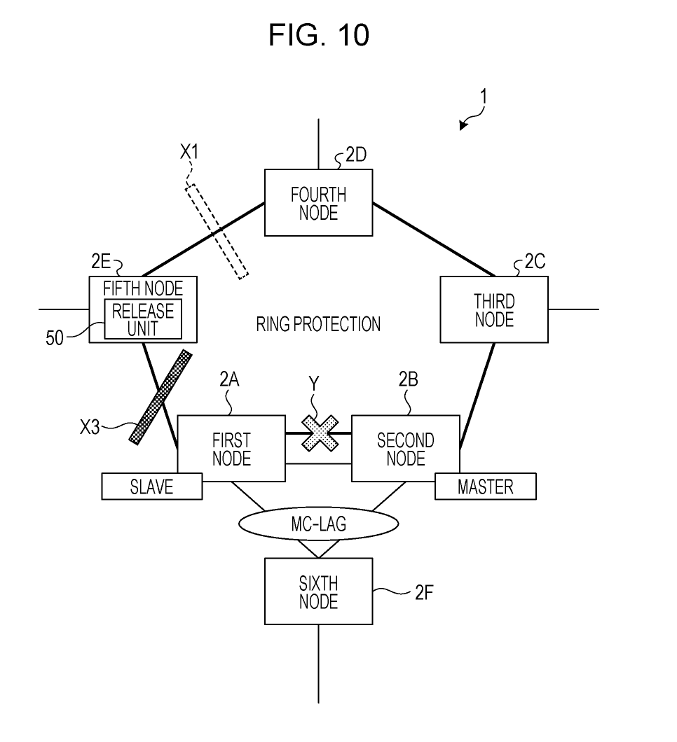

FIG. 10 is an explanatory diagram illustrating an example of the setting location of a blocking point before and after an inter-MC link failure according to a second embodiment. It is assumed that the first node 2A is a slave, and the second node 2B is a master. If the first node 2A detects a failure in the inter-MC link that is connected to the second node 2B, the first node 2A sets a blocking point X3 at the ring protection 1A side port P1 that connects to the fifth node 2E.

It is assumed that in the transmission system 1 illustrated in FIG. 10, for example, a blocking point X1 is set at the port on the link side in the fifth node 2E, which is connected to the fourth node 2D. Further, it is assumed that a failure Y occurs in the link between the first node 2A and the second node 2B, that is to say, in the inter-MC link.

If the first node 2A detects a failure Y in the inter-MC link with the second node 2B, the first node 2A notifies all the nodes 2 in the ring protection 1A of a failure notification signal. In this regard, the second node 2B may notify all the nodes 2 in the ring protection 1A of a failure notification signal. If the release unit 50 in the fifth node 2E detects a failure notification signal, the release unit 50 releases the set blocking point X1. Further, since the first node 2A is a slave, the first node 2A refers to the second setting table 33 and sets a blocking point X3 at the ring protection 1A side port P2 that connects to the fifth node 2E. As a result, it is possible to avoid a loop in the ring protection 1A such that a received frame from the sixth node 2F is returned to the sixth node 2F by the flooding of each node 2 in the ring protection 1A, which is caused by a failure in the inter-MC link.

In this regard, in the embodiment described above, a blocking point X1 is set at the port in the fifth node 2E that connects to the fourth node 2D in the ring protection 1A. However, it is not limited to the node 2, and it is possible to suitably change the setting.

In the first embodiment described above, out of the first node 2A and the second node 2B, if the node is a slave, a blocking point is set at the port that connects to the ring protection 1A side link. However, when the node is a master, a blocking point may be set at the port that connects to the ring protection 1A side link, and it is possible to suitably change the ports.

Also, each component of each device illustrated in the figures does not have to be physically configured as described in the figures. That is to say, the specific mode of distribution and integration of each device is not limited to that illustrated in the figures. It is possible to configure each device by functionally or physically distributing or integrating all of or a part of the device in any units depending on various loads and use states, and the like.

Further, all of or any part of the various processing functions performed by each device may be performed by a central processing unit (CPU) (or a microcomputer, such as a micro processing unit (MPU), a micro controller unit (MCU), or the like). Also, the various processing functions may be performed by programs that are analyzed and executed by a CPU (or a microcomputer, such as an MPU, an MCU, or the like), or by hardware using wired logic as a matter of course.

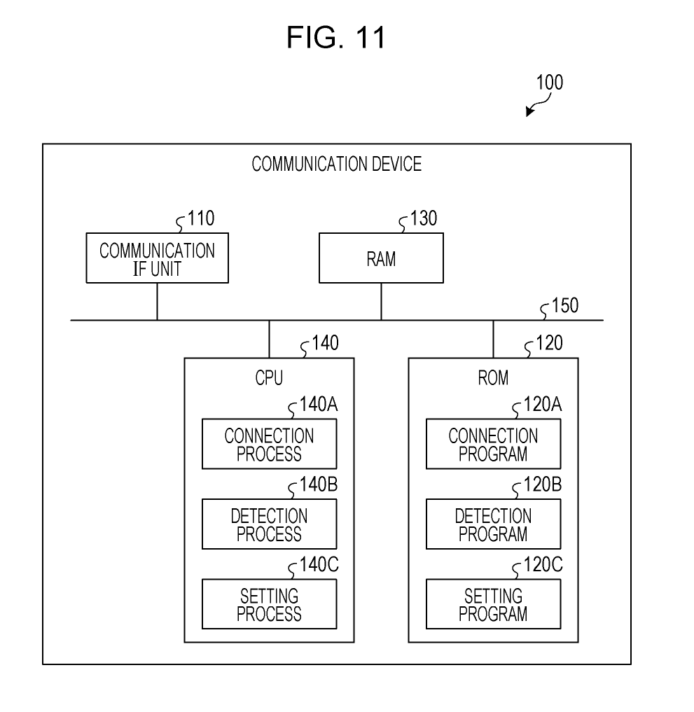

Incidentally, it is possible to realize the various kinds of processing described in the present embodiment by executing programs provided in advance by a processor, such as a CPU, or the like in the communication device. Thus, in the following, a description will be given of an example of the communication device that executes a program having the same functions as those of the embodiments described above. FIG. 11 is an explanatory diagram illustrating an example of a communication device that performs a loop prevention program.

The communication device 100, illustrated in FIG. 11, that executes the loop prevention program includes a communication IF unit 110, a ROM 120, a RAM 130, a CPU 140, and a bus 150. The communication device 100 is a transmission device that plays a role of an inter unit point between the ring protection and the MAC-LAG. The communication device 100 is one of the transmission devices out of the two transmission devices connected with each other among a plurality of first transmission devices in the ring protection. A bus 150 is a bus through which data is transmitted and received among the communication IF 110, the ROM 120, the RAM 130, and the CPU 140.

The ROM 120 then stores a loop prevention program that performs the same functions as the embodiments described above in advance. The ROM 120 stores a connection program 120A, a detection program 120B, and a setting program 120C as a loop prevention program. In this regard, the loop prevention program may be recorded in a computer-readable recording medium using an HDD rather than the ROM 120. Also, as a recording medium, a portable recording medium, for example, a CD-ROM, a DVD disc, a USB memory, or the like, or a semiconductor memory, such as a flash memory, or the like may be used.

The CPU 140 then reads a connection program 120A from the ROM 120 and functions as a connection process 140A. The CPU 140 reads a detection program 120B from the ROM 120 and functions as a detection process 140B. The CPU 140 reads the setting program 120C from the ROM 120 and functions as a setting process 140C.

The CPU 140 establishes a link aggregation connection with a second transmission device in cooperation with the other of the transmission devices. The CPU 140 detects a failure with the other of the transmission devices. If the CPU 140 detects a failure with the other of the transmission devices, the CPU 140 sets a blocking of the link side port connected to the first transmission device connected to one of the transmission devices. As a result, even if an inter-MC link failure occurs, it is possible to avoid the occurrence of a loop.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A transmission device being one of two transmission devices connected with each other among a plurality of transmission devices connected in a ring configuration in a ring protection link, the transmission device comprising:
a processor configured to
have a link aggregation connection with a second transmission device not included in the ring configuration,
detect a failure with one of the plurality of transmission devices connected in the ring configuration, and
when the failure is detected, set a blocking point at a link side port connecting the first transmission device to another one of the plurality of transmission devices connected in the ring configuration.

2. The transmission device according to claim 1,
wherein the processor records setting information indicating whether or not the transmission device is a master node or a slave node, and
based on the recorded setting information, when the transmission device is the predetermined device, the processor sets a blocking point at the link side port connecting the first transmission device to the another one of the plurality of transmission devices connected in the ring configuration.

3. The transmission device according to claim 1, further comprising:
a memory configured to store type information identifying a type of a link destination connected to the port for each identification information identifying a port in the transmission device,
wherein the processor identifies the type information corresponding to identification information of a port having an occurrence of a failure.

4. A transmission system including a plurality of first transmission devices connected in a ring configuration in a ring protection link, two second transmission devices connected with each other and having a link aggregation connection with a third transmission device in cooperation with each other, and any one of the first transmission devices configured to set a blocking point at a link side port connected with the another of the first transmission devices, the transmission system comprising:
one of the second transmission devices includes a processor configured to detect a failure with the another of the second transmission devices, and when a failure with the another of the second transmission devices is detected, notify any one of the first transmission devices of a failure notification signal;
the any one of the first transmission devices includes a release unit configured to release a blocking point being set when the failure notification signal is detected; and
the one of second transmission devices includes
the processor configured to set a blocking point at a link side port connected with the first transmission device connected to the one of the second transmission devices when a failure is detected with the another of the second transmission devices.

5. The transmission system according to claim 4,
wherein the one of the second transmission device records, by the processor, setting information indicating whether or not the one of the second transmission device is a predetermined device, and
based on the recorded setting information, when the one of the second transmission device is the predetermined device, the one of the second transmission device sets, by the processor, a blocking point at the link side port connecting the one of the second transmission device with one of the plurality of first transmission devices connected in the ring configuration.

6. The transmission system according to claim 4,
wherein the one of the second transmission device further includes:
a memory configured to store type information identifying a type of a link destination connected to the port for each identification information identifying a port in the one of the second transmission device,
wherein the processor identifies the type information corresponding to identification information of a port having an occurrence of a failure.

7. A loop prevention method performed by a transmission system including a plurality of first transmission devices connected in a ring configuration in a ring protection link, two second transmission devices connected with each another and having a link aggregation connection with a third transmission device in cooperation with the another, and any one of the first transmission devices configured to set a blocking point at a link side port connected with the another of the first transmission devices, the method comprising:
when one of the second transmission devices detects a failure with the another of the second transmission devices, notifying the any one of the first transmission devices of a failure notification signal;
when the failure notification signal is detected, releasing, by the any one of the first transmission devices, a block being set; and
when a failure is detected with the another of the second transmission devices, setting a block, by the one of the second transmission devices, at a link side port connected with the first transmission device connected to the one of the second transmission devices.

8. A transmission system comprising:
a plurality of transmission devices, including at least a first transmission device, a second transmission device, and a third transmission device, connected in a ring protection link;
a fourth transmission device not included in the ring protection link and connected to a first port of the first transmission device and a first port of the second transmission device via Multi-Chassis Link Aggregation (MC-LAG); and
an inter-multi-chassis link connecting a second port of the first transmission device and a second port of the second transmission device;
when the first transmission device detects a failure of the inter-multi-chassis link,
transmitting a failure notification signal to the plurality of transmission devices,
subsequent to receiving the failure notification signal at the third transmission device, removing by the third transmission device a block to a ring protection link connected a port of the third transmission device, and
blocking, by the first transmission device, a ring protection link connected a port of the first transmission device.

9. The transmission system of claim 8 further comprising:
an Inter Portal Link (IPL) connecting a third port of the first transmission device and a third port of the second transmission device.

10. The transmission system of claim 8 wherein the first transmission device and the second transmission device have a master or slave configuration.
